(19) United States
(12) Patent Application Publication
(10) Pub. No.: US 2004/0167252 A1
(43) Pub. Date: Aug. 26, 2004

(54) Aqueous coating compositions based on PU-PAC hybrid dispersions

(76) Inventors: Martin Melchiors, Leichlingen (DE); Thorsten Rische, Unna (DE); Markus Mechtel, Bergisch Gladbach (DE); Wieland Hovestadt, Leichlingen (DE); Torsten Pohl, Koln (DE); Raul Pires, Koln (DE)

Correspondence Address: BAYER POLYMERS LLC, 100 BAYER ROAD, PITTSBURGH, PA, 15205, US

(21) Appl. No.: 10/784,319

(22) Filed: Feb. 20, 2004

(30) Foreign Application Priority Data
Feb. 26, 2003 (DE) 10308103.8

(51) Int. Cl. C08L 1/00

(52) U.S. Cl. 524/13; 524/457; 524/507; 524/494

(57) ABSTRACT

The invention relates to aqueous polyurethane (PU)-polyacrylate (PAC) hybrid secondary dispersions and the aqueous two-component (2K) coating compositions produced therefrom, a process for their preparation and use.

### CROSS REFERENCE TO RELATED PATENT APPLICATION

The present patent application claims the right of priority under 35 U.S.C. §119 (a)-(d) of German Patent Application No.103 08 103.6, filed Feb. 26, 2003.

### FIELD OF THE INVENTION

The invention relates to aqueous polyurethane (PU)-polyacrylate (PAC) hybrid secondary dispersions and the aqueous two-component (2K) coating compositions produced therefrom, a process for their preparation and use.

### BACKGROUND OF THE INVENTION

Aqueous coating systems based on polyurethane-polyacrylate hybrid dispersions are already known and widespread in the coatings industry. The advantage of the physical blend as compared with separately prepared polyurethane and polyacrylate dispersions is that the hybrid dispersions unify the positive properties of polyurethane dispersions synergistically with those of polyacrylate dispersions. The polyurethane-polyacrylate hybrid dispersions are normally prepared by emulsion polymerization of a vinyl polymer (“polyacrylate”) in an aqueous polyurethane dispersion. It is, however, also possible to prepare the polyurethane-polyacrylate hybrid dispersions as a secondary dispersion.

Secondary dispersions are those aqueous dispersions which are first polymerized in a homogeneous organic medium and then redispersed in an aqueous medium with neutralization, generally without the addition of external emulsifiers.

WO-A 95/16004 describes, for example, water-thinnable paint binders based on oligourethane-acrylate copolymers. It subjects a monomer mixture of vinylically unsaturated monomers to free-radical polymerization in a water-dilutable organic solvent and in the presence of a water-soluble oligourethane having a molecular mass of from 750 to 1 000. This secondary dispersion is then used to formulate baking enamels.

DE-A 40 10 176 discloses oxidatively drying coating materials where the binder used comprises a polymer obtainable by polymerizing ethylenically unsaturated monomers in an organic solvent (A) in the presence (B) of a polyurethane resin containing polymerizable double bonds.

EP-A 657 483 describes aqueous two-component coating materials consisting of a polyisocyanate component and an aqueous polyurethane dispersion as polyol component. This polyol component is prepared by neutralizing and dispersing, unsaturated polyurethane macromers which contain lateral and/or terminal vinyl groups and are hydrophilicized with acid groups. Subsequently these PU macromers, where appropriate following the addition of further vinylic monomers, are free-radically polymerized in aqueous phase.

Finally, EP-A 742 239 discloses two-component coating systems based on polyisocyanate crosslinkers and aqueous hydroxy-terminated polyurethane prepolymer/acrylic hybrids. These hybrid polymers are obtained by reacting a water-dispersible NCO-functional urethane prepolymer with at least one hydroxy-functional acrylate monomer and an alkanolamine to give a hydroxy-functional urethane prepolymer/monomer mixture which is then dispersed in water. A free-radical initiator and a hydroxyl-containing chain extender are then added to this dispersion and subsequently, by heating of the aqueous. reaction mixture, both the free-radical polymerization of the acrylate monomers and the chain extension step of the polyurethane are carried out and completed. The hydroxy-functional polyurethane prepolymer/acrylic hybrid dispersions thus obtained can then be formulated to the ready-to-use two-component coating compositions by stirred incorporation of hydrophilicized polyisocyanates. A disadvantage here is the use of up to 6% of molecular weight regulators, based on acrylate monomer, such as thiols, which may adversely affect important coating properties such as resistance properties and film hardness.

Suitable polyurethane-polyacrylate hybrid secondary dispersions suitable for preparing two-component (2K) coating compositions, on the other hand, are not disclosed in the prior art.

A problem which affects all of the prior art systems is that of the incorporation of the polyisocyanate curative into the binder dispersion. The homogeneity of the two- component aqueous coating material greatly influences the gloss of the cured coatings.

It was therefore an object of the present invention to provide a PU-PAC hybrid dispersion into which polyisocyanates can be incorporated readily, thereby enabling the preparation of high-grade coating materials. The coatings ought in particular to have a very high gloss, generally more than 80% residual gloss at a 20° angle, fullness and transparency in combination with very good resistance properties, such as resistance to water, solvents, chemicals, the effects of weathering, such as UV stability and weather stability, and to mechanical stress, e.g. scratch resistance. The König pendulum hardnesses ought-to attain levels of more than 140 seconds. High-grade clearcoat and topcoat systems of this kind are used, for example, in automotive OEM finishing, automotive refinish, the finishing of large vehicles, the coating of plastics, or wood/furniture coating.

### SUMMARY OF THE INVENTION

The present invention is directed to a process for preparing polyurethane-polyacrylate hybrid secondary dispersions. The process includes:

(I) preparing a polyurethane (A) having an average molecular weight Mₙ, of from 1,100 to 10,000, which contains no polymerizable double bonds, in non-aqueous solution, in the presence where appropriate of vinylically unsaturated monomers which carry no groups that are reactive towards isocyanate groups,

(II) adding to the polyurethane solution (A), one or more vinylically unsaturated monomers (B) selected from at least one of the group containing

(B1) acid-finctional monomers,

(B2) hydroxyl- and/or amino-functional monomers,

(B3) other monomers different from (B1) and (B2),

and subjecting the resultant mixture to free-radical polymerization in a homogeneous, non-aqueous phase to provide a hybrid polymer,

(III) neutralizing at least some of the neutralizable groups, and

(IV) dispersing the hybrid polymer into the aqueous phase, wherein the neutralization can take place before or after the vinyl polymerization or during the dispersing step.

The present invention is also directed to a polyurethane-polyacrylate hybrid secondary dispersions obtained according to the above-described process. The dispersions can be used to coat substrates by applying the dispersions to substrates selected from concrete, screeding, mineral surfaces, wood, wood-based materials, metal, asphalt-containing or bituminous coverings, plastics surfaces, glass, glass fibres, carbon fibres, woven and non-woven textiles, leather, paper, hard fibres or straw and dried.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been found that the level of properties of the coating films with respect to the stated requirements can be improved significantly if the coating compositions comprise aqueous polyurethane-polyacrylate hybrid secondary dispersions obtained by virtue of the polymerization of the vinyl monomers taking place in the presence of the polyurethane in a non-aqueous phase, i.e. in bulk or prior to dispersion in the aqueous medium, without the need to use external emulsifiers or molecular weight regulators.

The present invention accordingly provides a process for preparing polyurethane- polyacrylate hybrid secondary dispersions, characterized in that

(I) a polyurethane (A) having a molecular weight Mₙ of from 1,100 to 10,000, preferably from 1,200 to 8,000 and more preferably from 1,500 to 6,000, which contains no polymerizable double bonds, is prepared in non-aqueous solution, in the presence where appropriate of vinylically unsaturated monomers which carry no groups that are reactive towards isocyanate groups,

(II) one or more vinylically unsaturated monomers (B) selected from at least one of the group containing

(B1) acid-functional monomers,

(B2) hydroxyl- and/or amino-functional monomers,

(B3) other monomers different from (B1) and (B2),

are added to the polyurethane solution from step (A) and subjected to free-radical polymerization in a homogeneous, non-aqueous phase,

(III) at least some of the neutralizable groups are neutralized, and

(IV) the hybrid polymer is subsequently dispersed into the aqueous phase, it being possible for neutralization to take place before or after the vinyl polymerization or during the dispersing step.

The invention likewise provides polyurethane-polyacrylate hybrid secondary dispersions obtainable by the process of the invention. The polyurethane (A) used to synthesize the PU-PAC hybrid secondary dispersions of the invention can be synthesized from the building blocks which are known fundamentally in paint chemistry.

The building blocks for preparing the polyurethane (A) are

(A1) Polyisocyanates,

and at least one compound which contains NCO-reactive groups and is selected from the group consisting of

(A2) polyols and/or polyamines having an average molecular weight Mₙ of at least 400,

(A3) compounds containing at least one ionic or potentially ionic group and at least one further isocyanate-reactive group and/or nonionically hydrophilicizing compounds containing at least one further isocyanate-reactive reactive group,

(A4) low molecular mass compounds having a molecular weight Mₙ of less than 400 which are different from (A2), (A3) and (A5) and contain at least two NCO-reactive groups

(A5) compounds which are monofinctional or contain active hydrogen of different reactivity, these building blocks being located in each case at the chain end of the polymer containing urethane groups.

Examples of polyisocyanates suitable as component (Al) include diisocyanates of the molecular weight range from 140 to 400 containing aliphatically, cycloaliphatically, araliphatically and/or aromatically bonded isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3) isocyanatomethylcyclohexane, bis(isocyanatomethyl)norbomane, 1,3- and 1,4-bis(2-isocyanatoprop-2-yl)benzene (TMXDI), 2,4- and 2,6-diisocyanato-toulene (TDI), 2,4′- and 4,4′-diisocyanatodiphenylmethane, 1,5-diisocyanaton-aphthalene or any desired mixtures of such diisocyanates.

The substances in question are preferably polyisocyanates or polyisocyanate mixtures of the stated type containing exclusively afiphatically and/or cycloaliphatically bonded isocyanate groups. Particularly preferred starting components (A1) are polyisocyanates or polyisocyanate mixtures based on HDI, IPDI and/or 4,4′-diisocyanatodicyclohexylmethane.

Further of suitability as polyisocyanates (A1) are any desired polyisocyanates which are synthesized from at least two diisocyanates, are prepared by modifying simple aliphatic, cycloaliphatic, araliphatic and/or aromatic diisocyanates, and have a uretdione, isocyanurate, urethane, allophanate, biuret, iminooxadiazine-dione and/or oxadiazinetrione structure, such as are described, for example, in J. Prakt. Chem. 336 (1994), pp. 185-200.

Suitable compounds containing NCO-reactive groups are polyols and/or polyamines (A2) which possess an average molecular weight Mₙ from 400 to 6,000, preferably from 600 to 2,500. Their OH number and/or NH number is generally from 22 to 400, preferably from 50 to 200, and their OH and/or NH functionality is greater than or equal to 1.6, preferably from 2 to 4. Examples of such polyols are polyetherpolyols, polyesterpolyols, polycarbonatepolyols, polyestercarbonatepolyols, polyesteramidepolyols, polyamidepolyols, epoxy resin polyols and their reaction products with C0₂, poly(meth)acrylatepolyols, polyacetalpolyols, saturated and unsaturated, unfluorinated or fluorinated hydrocarbon-polyols and polysiloxanepolyols. Of these polyols the polyether-, polyesterpolyols and polycarbonatepolyols are preferred, particular preference being given to those which have only terminal OH groups and which possess a functionality of greater than or equal to 1.6, preferably from 2 to 4.

Instead of OH groups the compounds of component (A2) may also contain, proportionally or exclusively, primary or secondary amino groups as NCO-reactive groups.

Suitable polyetherpolyols are the polytetramethylene glycol polyethers which are known per se in polyurethane chemistry and can be prepared, for example, by polymerizing tetrahydrofuran by means of cationic ring openings. Polyetherpolyols suitable additionally are, for example, the polyols prepared, using starter molecules, from ethylene oxide, styrene oxide, propylene oxide, butylene oxide or epichlorohydrin, and also copolymers of the stated cyclic monomers.

Suitable polyesterpolyols of the known polycondensates of di- and also, where appropriate, poly(tri,tetra)ols and di- and also, where appropriate, poly(tri,tetra)-carboxylic acids or hydroxycarboxylic acids or lactones. Instead of the free polycarboxylic acids it is also possible to use the corresponding polycarboxylic anhydride or corresponding polycarboxylic esters of lower alcohols to prepare the polyesters.

Examples of suitable diols are ethylene glycol, butylene glycol, diethylene glycol, triethylene glycol, polyalkylene glycols such as polyethylene glycol, and also propanediol, butane-1,4-diol, hexane-1,6-diol, neopentyl glycol or neopentyl glycol hydroxypivalate. If desired it is possible as well to use polyols are such as, for example, trimethylolpropane, glycerol, eythritol, pentaerythritol, trimethylolbenzene or trishydroxyethylisocyanurate.

Examples of suitable dicarboxylic acids include phthalic acid, isophthalic acid, terephthalic acid, tetrahydrophthalic acid, hexahydrophthalic acid, cyclohexane-dicarboxylic acid, adipic acid, azelaic acid, sebacic acid, glutaric acid, tetrachloro-phthalic acid, maleic acid, fumaric acids, itaconic acid, malonic acid, suberic acid, 2-methylsuccinic acid, 3,3-diethylgiutaric acid and 2,2-dimethyl-succinic acid. The possible anhydrides of these acids are likewise suitable. For the purposes of the present invention, consequently, the anhydrides are embraced by the expression “acid”. It is also possible to use monocarboxylic acids, such as benzoic acid, hexanecarboxylic acid or fatty acids, provided that the average functionality of the polyol is greater than 2. Saturated aliphatic or aromatic acids are preferred, such as adipic acid or isophthalic acid. In smaller amounts it is possible to use polycarboxylic acids such as trimellitic acid. Examples of hydroxycarboxylic acids, which can be used as reactants when preparing a polyesterpolyol having a terminal hydroxyl group, include hydroxycaproic acid, hydroxybutyric acid, hydroxy-decanoic acid or hydroxystearic acid. Examples of suitable lactones include ε-caprolactone or butyrolactone.

The hydroxyl-containing polycarbonates that are suitable are obtainable by reacting carbonic acid derivatives, e.g. diphenyl carbonate, dimethyl carbonate or phosgene, with diols. Examples of suitable such diols include ethylene glycol, 1,2- and and 1,3-propanediol, 1,3- and 1,4-butanediol, 1,6-hexanediol, 1,8-octanediol, neopentyl glycol, 1 ,4-bishydroxymethylcyclohexane, 2-methyl-1,3-propanediol, 2,2,4-trime-thylpentane-1,3-diol, dipropylene glycol, polypropylene glycols, dibutylene glycol, polybutylene glycols, bisphenol A, tetrabromobisphenol A but also lactone-modified diols. The diol component preferably contains from 40 to 100% by weight of hexanediol, preferably 1,6-hexanediol and/or hexanediol derivatives, with particular preference to those which in addition to terminal OH groups contain ether groups or ester groups. The hydroxyl polycarbonates are preferably linear. They can, however, have a low level of branching where appropriate through the incorporation-of polyfunctional components, especially low molecular mass polyols. Examples of compounds suitable for this purpose include glycerol, trimethylolpropane, hexane-1,2,6-triol, butane-1,2,4-triol, trimethylolpropane, pentaerythritol, quinitol, marinitol and sorbitol, methyl glycoside or 1,3,4,6-dianhydrohexitols.

Components (A3) serves to hydrophilicize the polyurethane. The dispersibility of the PU-PAC hybrid polymer can take place both by way of the polyurethane and by way of the polyacrylate. Examples of ionic or potentially ionic compounds suitable as component (A3) include mono- and dihydroxycarboxylic acids, mono- and diaminocarboxylic acids, mono- and dihydroxysulphonic acids, mono- and diaminosulphonic acids and also mono- and dihydroxyphosphonic acids and/or mono- and diaminophosphonic acids and their salts such as dihydroxycarboxylic acids, hydroxypivalic acid, N-(2-aminoethyl)-β-alanine, 2-(2-aminoethylamino)-ethanesulphonic acid, ethylenediamine-propyl- or -butylsulphonic acid, 1,2- or 1,3-propylenediamine-β-ethylsulphonic acid, lysine, 3,5-diaminobenzoic acid, the hydrophilicizing agent from Example 1 of EP-A 0 916 647 and the alkali metal - and/or ammonium salts thereof; the adduct of sodium bisulphite with but-2-ene-1,4-diol, polyethersulphonate, the propoxylated adduct of 2-Butenediol and NaHSO₃ (e.g. in DE-A 2 446 440, page 5-9, formula I-III) and also building blocks which can be converted into cationic groups such as N-methyldieth-anolamine as hydrophilic synthesis components. Preferred ionic or potential ionic compounds (A3) are those which possess carboxyl or carboxylate- and/or sulphonate groups. Particularly preferred ionic compounds (A3) are dihydroxy-carboxylic acids, with very particular preference α,α-dimethylolalkanoic acids, such as 2,2-dimethylolacetic acid, 2,2-dimethylolpropionic acid, 2,2-dimethylol-butyric acid, 2,2-dimethylolpentanoic acid or dihydroxysuccinic acid.

Additionally as component (A3) it is also possible to use nonionically hydrophilicizing compounds, e.g. polyoxyalkylene ethers containing at least one hydroxyl or amino group. These polyethers contain a fraction of from 30% by weight to 100% by weight of building blocks derived from ethylene oxide. They suitably include polyethers of linear construction with a finctionality of between 1 and 3, but also compounds of the general formula (I),

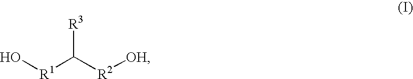

in which

R¹ and R² independently of one another are each a divalent aliphatic, cycloaliphatic or aromatic radical having 1 to 18 carbon atoms which can be interrupted by oxygen and/or nitrogen atoms, and

R³ is a non-hydroxy-terminated polyester or, preferably, polyether, more preferably an alkoxy-terninated polyethylene oxide radical.

The low molecular mass NCO-reactive compounds (A4) to be used optionally for the synthesis of the polyurethane (A) generally have the effect of stiffening the polymer chain. They generally possess a molecular weight of from about 62 to 400, preferably from 62 to 200, and can contain aliphatic, alicyclic or aromatic groups.

Examples are

a) alkanediols and -polyols, such as ethanediol, 1,2- and 1,3-propanediol, 1,4- and 2,3-butanediol, 1,5-pentanediol, 1,3 dimethylpropanediol, 1,6-hexanediol, neopentyl glycol, cyclohexanedimethanol, 2-methyl-1,3-propanediol, bisphenol A (2,2-bis(4-hydroxyphenyl)propane), hydrogenated Bisphenol A (2,2-bis(4-hydroxycyclohexyl)propane), trimethylolpropane, glycerol or pentaerythritol,

b) ether diols, such as diethylene diglycol, triethylene glycol or hydroquinone dihydroxyethyl ether,

c) ester diols of the general formulae (II) and (II),

HO—(CH₂)ₓ—CO—O—(CH₂)_{y}—OH (II),

HO—(CH₂)ₓ—O—CO—R—CO—O(CH₂)_{x—OH} (III),

in which R is an alkylene or arylene radical having 1 to 10 carbon atoms, preferably 2 to 6 carbon atoms, x=2 to 6 and y=3 to 5, such as δ-hydroxybutyl-ε-hydroxycaproic esters, ω-hydroxyhexyl-γ-hydroxybutyric esters, (β-hydroxyethyl) adipate and bis(β-hydroxyethyl) terephthalate and

d) di- and polyamines such as ethylene diamine, 1,2- and 1,3-diaminopropane, 1,4-diaminobutane, 1,6-diaminohexane, isophoronediamine, isomer mixture of 2,2,4- and 2,4,4-trimethylhexamethylenediamine, 2-methylpentam-ethylenediamine, diethylenetriamine, 1,3- and 1,4-xylylenediamine, α,α,α′,α′-tetramethyl-1,3- and -1,4-xylylenediamine and 4,4-diaminodicyclohexylmethane. Also understood as diamines in the sense of the invention are hydrazine, hydrazine hydrate and substituted hydrazines, such as N-methylhydrazine, N,N′-dimethylhydrazine and homologues thereof and also acid dihydrazides, such as adipic dihydrazide, semicarbazidoalkylene hydrazides, such as β-semicarbazidopropionic hydrazide, semicarbazidoalkylene carbazine esters, such as 2-semicarbazidoethyl carbazine esters or else aminosemicarbazide compounds, such as β-aminoethyl semicarbazidocarbonate.

The polyurethane component (A) may also include building blocks (A5) which are located in each case at the chain ends and cap them. These building blocks are derived on the one hand from monofunctional, NCO-reactive compounds, such as monoamines, preferably from mono-secondary amines or monoalcohols. Mention may be made here, by way of example, of methylainine, ethylamine, propylamine, butylamine, octylamine, laurylamine, stearylamine, isononyloxypropylamine, dimethylamine, diethylamine, dipropylamine, dibutylamine, n-methylamino-propylamine diethyl(methyl)aminopropylamine, morpholine, piperidine or their suitable substituted derivatives, amide amines formed from diprimary amines and monocarboxylic acids, monoketimes of diprimary amines, primary/tertiary amines, such as N,N-dimethylaminopropylamine.

Preferred for (A5) are those compounds which contain active hydrogen having different reactivity towards NCO groups, such as compounds which contain secondary amino groups as well as a primary amino group or contain COOH groups as well as an OH group or contain OH groups as well as an amino group (primary or secondary), the latter compounds being particularly preferred. Examples thereof are primary/secondary amines, such as 3-amino-1-methylaminopropane 3-amino-1-ethylaminopropane, 3-amino-1-cyclohexyl-aminopropane, 3-amino-1-methylaminobutane, mono-hydroxycarboxylic acids, such as hydroxyacetic acid, lactic acid or malic acid, and also alkanolamines such as N-aminoethylethanolamine, ethanolamine, 3-aminopropanol, neopentanolamine and, with particular preference, diethanolamine. In this way finctional groups are introduced additionally into the polymeric end product.

The polyurethane (A) can be prepared, for example, by first preparing an isocyanate-functional prepolymer and in a second reaction step, by reaction with compounds (A4) and/or (A5) obtaining an OH-functional compound.

The polyurethane resin (A) is preferably prepared by first preparing, from the polyisocyanates (A1), the polyols (A2) and the low molecular mass polyols (A4) and also, where appropriate, the compounds (A3), a polyurethane prepolymer containing on average per molecule at least 1.7, preferably from 2 to 2.5 free isocyanate groups, then reacting this prepolymer with compounds (A4) and/or (A5) in a non-aqueous, system to give an NCO-free polyurethane resin (A). The polyurethane (A) is prepared preferably in the presence of at least a portion of the free-radically polymerizable monomers (B) which carry no isocyanate-reactive groups.

Alternatively the preparation can take place such that the polyurethane resin (A) is formed directly by reaction of components (A1) to (A5). Any anionic groups present in the polyurethane (A) can be neutralized, at least proportionally, with bases before or after the vinyl polymerization or else during the dispersing step with water.

The reaction for preparing the polyurethane (A) is normally conducted at temperatures from 60 to 140° C., depending on the reactivity of the isocyanate employed. In order to accelerate the urethanization reaction it is possible to use suitable catalysts. Examples are tertiary amines such as triethylamine, organotin compounds such as dibutyltin oxide, dibutyltin dilaurate or tin bis(2-ethylhexanoate) or other organometallic compounds. The urethanization reaction is conducted preferably in the presence of solvents which are inert towards isocyanates, such as ethers, ketones, esters or N-methylpyrrolidone. The amount of these solvents appropriately does not exceed 25% by weight and is situated preferably in the range from 0 to 15% by weight, based in each case on the sum of the polyurethane resin and solvent. The urethanization reaction can also be conducted in the presence. of at least a portion of the vinyl monomers which later form the vinyl polymer fraction of the hybrid polymer of the invention and which do not carry any functional groups which are isocyanate-reactive (under the chosen reaction conditions). In the case of this version the possibility exists of dispensing with the use of the solvents set out above or of reducing their amount.

Taking place subsequently in accordance with the invention is the polymerization of the vinyl. monomers in the presence of the polyurethane .(A) and, if desired, in the presence of further organic cosolvents and/or auxiliary solvents, but before transfer of the polyurethane to the aqueous phase.

Free-radically polymerizable vinyl monomers are selected from at least one of the group containing

(B1) acid-finctional polymerizable monomers,

(B2) hydroxy- and/or NH-functional polymerizable monomers,

(B3) further polymerizable monomers different from (B1) and (B2)

Overall the PU-PAC hybrid polymer is internally hydrophilicized. This hydrophilicization can take place by way of the polyurethane (A), by using component (A3) and/or the polyacrylate moiety, by using component (B1). Preferably the polyacrylate moiety is hydrophilicized. Component (B1) suitably includes unsaturated free-radically polymerizable compounds having carboxyl/carboxylate groups or sulphonic acid/sulphonate groups. Examples of such acid-functional monomers (B1) are, for example, acrylic acid, methacrylic acid, β-carboxyethyl acrylate, crotonic acid, fumaric acid, maleic acid (anhydride), itaconic acid, monoalkyl esters of dibasic acids/anhydrides such as maleic monoalkyl esters, for example, and also the olefinically unsaturated monomers which contain sulphonic acid/sulphonate groups and are described in WO-A 00/39181 (p. 8 line 13-p. 9 line 19), among which 2-acrylamido-2-methylpropanesulphonic acid may be mentioned by way of example. It is preferred to use carboxy-finctional monomers, with particular preference acrylic acid and/or methacrylic acid.

Component (B2) suitably includes in principle all OH- or NH-functional monomers containing free-radically polymerizable C═C double bonds. Preference is given here to hydroxy-finctional monomers. Examples of suitable hydroxy-functional monomers (B2) are hydroxyethyl methacrylate, hydroxypropyl methacrylate, hydroxyethyl acrylate, hydroxypropyl acrylate, hydroxybutyl acrylate, hydroxybutyl methacrylate or hydroxy monomers containing alkylene oxide units, such as adducts of ethylene oxide, propylene oxide or butylene oxide with (meth)acrylic acid, (meth)acrylic hydroxy esters or (meth)allyl alcohol, and also the monoallyl and diallyl ethers of trimethylolpropane, glycerol or pentaerythritol. Particular preference is given to hydroxyethyl acrylate, hydroxyethyl methacrylate, hydroxypropyl acrylate, hydroxypropyl methacrylate, hydroxybutyl acrylate or hydroxybutyl methacrylate.

Examples of suitable monomers (B3) are (meth)acrylic esters with C₁ to C₁₈ hydro-carbon radicals in the alcohol moiety, examples being methyl acrylate, ethyl acrylate, n-butyl acrylate, isobutyl acrylate, tert-butyl acrylate, 2-ethylhexyl acrylate, methyl methacrylate, ethyl methacrylate, butyl methacrylate, 2-ethylhexyl methacrylate, hexyl acrylate, lauryl acrylate, monomers containing cyclic hydrocarbon radicals such as cyclohexyl (meth)acrylate, cyclohexyl (meth)acrylates substituted on the ring by alkyl groups, isobomyl (meth)acrylate or norbomyl (meth)acrylate, monomers containing aromatic groups such as styrene, vinyltoluene or α-methylstyrene, but also vinyl esters, vinyl monomers containing alkylene oxide units such as, for example, condensation products of (meth)acrylic acid with oligoalkylene oxide monoalkyl ethers and also monomers with further functional groups such as epoxy groups, alkoxysilyl groups, urea groups, urethane groups, amide groups or nitrile groups, for example. Additionally, (meth)acrylate monomers and/or vinyl monomers with a functionality of two or more, such as hexanediol di(meth)acrylate, ethylene glycol diacrylate, for example, can be used in amounts of 0-5% by weight, preferably 0-2% by weight based on the sum of the monomers (B1) to (B3). Preference is given to using methyl methacrylate, n-butyl acrylate, n-butyl methacrylate, 2-ethylhexyl acrylate, isobomyl acrylate, isobomyl methacrylate or styrene.

Suitable initiators for the polymerization reaction include organic peroxides such as di-tert-butyl peroxide or tert-butyl peroxy-2-ethylhexanoate and also azo compounds. The amounts of initiator used depend on the desired molecular weight. For reasons of process reliability and of greater ease of handling it is possible also to use peroxide initiators as a solution in suitable organic solvents of the type described in more detail below.

It is preferred for the polyurethane-polyacrylate hybrid polymer of the invention to contain hydroxyl groups both in the polyurethane fraction (A) and in the polyacrylate fraction (B).

The aqueous hybrid dispersions of the invention are prepared by polymerizing components (B1) to (B3) and also the initiator component and, where appropriate, additional organic cosolvents in the presence of the solution or melt of the polyurethane (A), and the polyurethane-polyacrylate hybrid polymer is formed. The free-radical polymerization can be conducted in organic phase by polymerization techniques known per se in paint chemistry.

In the process of the invention the free-radical polymerization is preferably conducted such that at the end the fraction of the acid-functional monomers in the monomer mixture is higher than at the beginning. This can be done in a multi-stage polymerization technique, to be used as described, for example, in EP-A 0 947 557 (p. 3 line 2-p. 4 line 15) or in EP-A 1 024 184 (p. 2 line 53-p. 4 line 9), in which first of all a comparatively hydrophobic, low-acid-group-content or acid-group-free monomer mixture and then, at a later point in time in the polymerization, a more hydrophilic, acid-group-containing monomer mixture is metered in. Instead of a multi-stage polymerization technique it is likewise possible to conduct the operation continuously (gradient polymerization), i.e., a monomer mixture with changing composition is added, with the hydrophilic monomer fractions being higher towards the end of the feed than at the beginning.

The copolymerization is conducted generally at 60 to 180° C., preferably from 80 to 160° C. in the presence of the polyurethane (A). If desired it is possible to add further organic cosolvents or auxiliary solvents before, during or after the polymerization. Suitable cosolvents or auxiliary solvents the solvents known in coatings technology, preference being given to those which are commonly used as cosolvents in aqueous dispersions, such as alcohols, ethers, alcohols containing ether groups, esters, ketones, N-methylpyrrolidone or apolar hydrocarbons or mixtures thereof. The solvents are used in amounts such that the solvent content in the finished dispersion is from 0 to 20% by weight, preferably from 0 to 10% by weight. If necessary it is also possible for the solvents used to be partly removed again by a distillation, if particularly low organic solvent contents are required.

The weight-average molecular weight M_{w} of the polyurethane-polyacrylate hybrid polymers is generally between 1 000 and 50,000 and preferably between 2,000 and 30,000. The OH content of the hybrid polymers in 100% form is from 1 to 10% by weight, preferably from 2.5 to 8% by weight. The acid group content, which constitutes the sum of carboxyl/carboxylate and sulphonic acid/sulphonate groups, of the hybrid polymers in 100% form is from 10 to 90 meq/100 g, preferably from 15 to 70 meq/100 g.

The hybrid polymer thus formed is subsequently transferred to the aqueous phase, with the acid groups present in the polyurethane moiety and/or in the polyacrylate moiety being at least partly neutralized before or during the dispersing operation. In the dispersing step it is possible to add either the resin to the water or water to the resin or to meter in both components simultaneously with one another. To neutralize the acid groups incorporated in the hybrid polymer it is possible to use organic amines or water-soluble inorganic bases (e.g. soluble metal hydroxides). Examples of suitable amines are N-methylmorpholine, triethylamine, diisopropylethylamine, dimethylethanolamine, dimethylisopropanolamine, methyldiethanolamine, diethylethanolamine, butanolamine, morpholine, 2-aminomethyl-2-methyldiethanolamine, N,N-dimethyl-aminoethyl acrylate or isophoronediamine. Ammonia too can be used additionally. The neutralizing agent is added in amounts such that the degree of neutralization (i.e. the molar ratio of neutralizing agent to acid) is from 40 to 150%, preferably from 60 to 120%. The pH of the aqueous crosslinkable polyurethane-polyacrylate hybrid dispersions of the invention is from 6.0 to 11.0, preferably from 6.5 to 9.0, and have a solids content of from 20 to 70%, preferably from 25 to 60% and with very particular preference from 30 to 60%.

The polyurethane-polyacrylate hybrid secondary dispersions of the invention can be processed to aqueous coating compositions. The present invention accordingly likewise provides aqueous two-component (2Ks) coating compositions comprising the binder dispersions of the invention and also at least one crosslinker.

By two-component coating materials in the sense of the present invention are meant coating compositions in which binder component and crosslinker component must be stored in separate vessels on account of their high reactivity. The two components are not mixed until shortly before application, when they react generally without additional activation. In order to accelerate the crosslinking reaction, however, it is also possible to use catalysts or to employ elevated temperatures.

Examples of suitable crosslinkers are polyisocyanate crosslinkers, amide- and amine-formaldehyde resins, phenolic resins, aldehyde resins and ketone resins, such as phenbl-formaldehyde resins, resoles, furan resins, urea resins, carbamic ester resins, triazine resins, melamine resins, benzoguanamine resins, cyanamide resins, and aniline resins, as described in “Lackkunstharze”, H. Wagner, H. F. Sarx, Carl Hanser Verlag Munich, 1971. Preference is given to polyisocyanate crosslinkers.

It is particularly preferred to use low-viscosity hydrophobic or hydrophilicized polyisocyanates containing free isocyanate groups based on aliphatic, cycloaliphatic, araliphatic and/or aromatic isocyanates, preferably aliphatic or cycloaliphatic isocyanates, since in that way it is possible to attain a particularly high resistance level of the coating film. These polyisocyanates generally have at 23° C. a viscosity fromt 10 to 3,500 mPas. If necessary the polyisocyanates can be employed as a blend with small amounts of inert solvents in order to lower the viscosity to a figure within the stated range. Triisocyanatononane as well can be used, alone or in mixtures, as a crosslinker component.

The polyurethane-polyacrylate hybrid polymer described here is generally sufficiently hydrophilic to ensure the dispersibility of the crosslinker resins, unless the substances in question are water-soluble or water-dispersible anyway.

Also possible in principle, of course, is the use of mixtures of different crosslinker resins.

Besides crosslinkable polyurethane-polyacrylate hybrid secondary dispersions the aqueous 2K coating compositions may where appropriate comprise other binders or dispersions, based for example on polyesters, polyurethanes, polyethers, polyepoxides or polyacrylates, and also, where appropriate, pigments and other auxiliaries and additives known in the coatings industry. The auxiliaries and additives, such as defoamers, thickeners, pigments, dispersing aids, catalysts, anti-skinning agents, anti-settling agents or emulsifiers, can be added before, during or after the dispersing step of the hybrid polymer, preferably with or after the addition of the crosslinker.

The aqueous 2K coating compositions obtained in this way, comprising the polyurethane-polyacrylate hybrid secondary dispersions of the invention, are suitable for all fields of use in which aqueous painting and coating systems with stringent requirements concerning the resistance of the films are used, e.g. coating of mineral construction material surfaces such as concrete or screeding, coating and sealing of wood and wood-based materials, coating of metallic surfaces (metal coating), coating and varnishing of asphaltic or bituminous coverings, coating and sealing of various plastics surfaces (plastics coating), glass, glass fibres, carbon fibres, woven and non-woven textiles, leather, paper, hard fibres, straw and also high-gloss coating materials. Preference is given to the coating of metallic surfaces and of plastics surfaces. The aqueous 2K coating compositions comprising the polyurethane-polyacrylate hybrid secondary dispersions of the invention are used for producing primers, surfacers, pigmented or transparent topcoat materials, clearcoat materials, and high-gloss coating materials, and also one-coat coating materials which can be employed in individual application and series application, e.g. in the sector of industrial coating, automotive OEM finishing and automotive refinish, and also floor coating.

The present specification likewise provides substrates coated with aqueous coating compositions comprising the polyurethane-polyacrylate hybrid secondary dispersions of the invention.

### EXAMPLES

All figures in % refer to the weight. Viscosity measurements were conducted in a cone and plate viscometer to DIN 53019 at a shear rate of 40 s⁻¹.

### Example 1

### Preparation of an Inventive Hybrid Dispersion

99.2 g of a polyester prepared from 47 parts of hexahydrophthalic anhydride and 53 parts of 1,6-hexanediol, with an OH number of 53 and an acid number below 3, are heated together with 9.6 g of 1,4-butanediol and 0.2 g of tin(II) octoate to 80° C. and held at this temperature until there is a homogeneous solution. Then 31.2 g of Desmoduro® W (4,4′-diisocyanatodicyclohexylmethane, Bayer AG, Leverkusen, DE) are added over the course of 2 minutes with stirring and the reaction mixture is heated to 140° C. and stirred at 140° C. for 2 h. The polyurethane has an average molar weight Mₙ of 3 940 g/mol. The polyurethane is dissolved by adding 46.7 g of propylene glycol n-butyl ether and stirred for 10 minutes more. Over the course of 2 h a solution of 95.3 g of hydroxyethyl methacrylate, 33.8 g of styrene and 34.1 g of 2-ethylhexyl acrylate is metered in. Added dropwise in parallel thereto over the course of 3.5 h is a solution of 24.0 g of di-tert-butyl peroxide and 24.0 g of propylene glycol n-butyl ether. After the end of the addition of solution 1 a mixture of 38.8 g of hydroxypropyl methacrylate, 20.0 g of n-butyl acrylate and 14.0 g of acrylic acid is metered in directly over the course of 1 h. Following the addition of solution 2 the reaction mixture is stirred at 140° C. for a further 2 h, then cooled to 100° C., admixed with 15.6 g of dimethyleth-anolamine and homogenized for 10 min. Dispersion takes place by addition of 529.3 g of water over the course of 5 minutes. This gives a dispersion having a concentration of 40% and an OH content of 4.4% by weight in terms of resin solids, whose particles have an average size of 144 nm. The hybrid resin has an average molar weight M_{w} of 14,295 g/mol.

### Example 2

### Preparation of an Inventive Hybrid Dispersion

99.2 g of a polyester prepared from 47 parts of hexahydrophthalic anhydride and 53 parts of 1,6-hexanediol, with an OH number of 53 and an acid-number below 3, are heated together with 9.6 g of 1,4-butanediol and 0.2 g of tin(II) octoate to 80° C. and held at this temperature until there is a homogeneous solution. Then 31.2 g of Desmodur® W (4,4′-diisocyanatodicyclohexylmethane, Bayer AG, Leverkusen, DE) are added over the course of 2 minutes with stirring and the reaction mixture is heated to 140° C. and stirred at 140° C. for 2 h. The polyurethane has an average molar weight Mₙ of 3 940 g/mol. The polyurethane is dissolved by adding 46.7 g of propylene glycol n-butyl ether and stirred for 10 minutes more. Over the course of 2 h a solution of 105.2 g of hydroxypropyl acrylate, 41.2 g of styrene and 16.8 g of 2-ethylhexyl acrylate is metered in. Added dropwise in parallel thereto over the course of 3.5 h is a solution of 24.0 g of di-tert-butyl peroxide and 24.0 g of propylene glycol n-butyl ether. After the end of the addition of solution 1 a mixture of 38.8 g of hydroxypropyl methacrylate, 19.6 g of n-butyl acrylate, 8.6 g of styrene and 5.0 g of acrylic acid is metered in directly over the course of 1 h. Following the addition of solution 2 the reaction mixture is stirred at 140° C. for a further 2 h, then cooled to 100° C., admixed with 6.5 g of dimethylethanolamine and homogenized for 10 min. Dispersion takes place by addition of 529.3 g of water over the course of 5 minutes. This gives a dispersion having a concentration of 39.3% and an OH content of 4.5% by weight in terms of resin solids, whose particles have an average size of 173.3 nm. The hybrid resin has an average molar weight M_{w} of 21,382 g/mol.

### Example 3

### Comparative Example from EP-A 742 239 (Example 1, Page 7)

As a comparative example the Example 1 described on page 7, line 19 ff. of EP-A 742 239 was reproduced. The hybrid resin thus obtained has an average molar weight M_{w} of 14,556 g/mol; the dispersion has a solids content of 42.0%, an average particle size of 67.0 nm and a pH of 8.44.

### Example 4

### Comparative Example from EP 742239 (Example 1-1, Page 15)

As a comparative example the Example 1-1 described on page 15 of EP-A 742 239 was reproduced. The average molar weight M_{w} of the hybrid resin thus obtained can no longer be measured by means of GPC. It should therefore have an average molar weight M_{w} of above 500,000.

### Example 5:

### Comparative Example from EP-A 657 483 (Example 1, Page 9)

As a comparative example the Example 1 described on page 9, line 38 ff. of EP-A 657 483 was reproduced. The hybrid resin thus obtained has, an average molar weight M_{w} of 11,400 g/mol; the dispersion has a solids content of 33%, an average particle size of 104.6 nm and a pH of 6.95.

### Example 6-10

### Performance Examples, Formulation of an Aqueous 2K Clearcoat Material

Products used:

| | |
|---|---|
| Bayhydur ® | hydrophilicized, cycloaliphatic, isocyanurate-group- |
| VPLS 2319: | containing polyisocyanate, Bayer AG, Leverkusen, |
| | DE. It is used in Examples 6-10 as an 80% strength |
| | solution in methoxybutyl acetate, |
| Surfynol ® 104 BC: | levelling additive, defoamer, Air Products, Utrecht, |
| | NL |
| Borchigel ® | thickener, Borchers AG, Monheim, DE |
| PW 25: | |
| Baysilone ® | slip additive, Borchers AG, Monheim, DE |
| VP AI 3468: | |
| Tinuvin ® 1130: | UV absorber, Ciba Spezialitaten GmbH, |
| | Lampertheim, DE |
| Tinuvin ® 292: | HALS amine, Ciba-Spezialitaten GmbH, |
| | Lampertheim, DE |
| Byk ® 345: | levelling agent, Byk Chemie, Wesel |
| Byk ® 333: | levelling, Byk Chemie, Wesel |
| Desmodur ® | aliphatic polyisocyanate based on hexamethylene |
| N 3600: | diisocyanate, Bayer AG, Leverkusen, DE |

Aqueous 2K clearcoat materials are formulated from the dispersions of Examples 1-5 in accordance with the formulas in Table 1. The polyisocyanate is incorporated using a Dispermat at 2,000 rpm for 2 min. The aqueous coating materials thus obtained are subsequently adjusted by adding water to a processing viscosity of between 20? and 25? (measured in the DIN 4 cup at 23° C.). The aqueous coating materials are sprayed (dry film thickness 40-60 μm) onto a metal panel coated with an aqueous basecoat (Permahyd®, Spies-Hecker, Cologne, DE), flashed off at room temperature for 30min and baked at 60° C. for 30 min. The results of coatings testing are compiled in Table 1.

TABLE 1
Performance examples using the dispersions from Examples 1-5

| | Example 6 | Example 7 | Example 8 | Example 9 | Example 10 |
|---|---|---|---|---|---|
| Binder | Example 1 | Example 2 | Example 3 | Example 4 | Example 5 |
| Curative (Bayhydur ®-) | VPLS | VPLS | VPLS | VPLS | VPLS |
| | 2319 | 2319 | 2319 | 2319 | 2319 |
| Mixing ratio | 100/40.1 | 100/44.8 | 100/24.6 | 100/7.9 | 100/36.8 |
| binder/curative | | | | | |
| Binder [g] | 250.6 | 223.3 | 281.7 | 358.5 | 267.9 |
| Surfynol ® 104 BC [g] | 5.2 | 5.2 | 5.2 | 5.2 | 5.1 |
| Borchigel ® PW 25 [g] | 0.7 | 0.7 | 0.7 | 0.7 | 0.7 |
| Baysilone ® VP AI 3468 | 4.3 | 4.3 | 4.3 | 4.3 | 4.3 |
| [g] | | | | | |
| Curative [g] | 104.5 | 104.5 | 71.9 | 29.1 | 102.4 |
| Water [g] | 64.3 | 47.4 | 77.1 | 54.7 | 106.4 |
| Coating properties: | | | | | |
| Gloss (20°)¹⁾ | 86 | 85 | 83 | 16 | 3 |
| Haze²⁾ | <10 | <10 | <10 | 33 | — |
| Levelling (visual) | 1 | 1 | 1 | 4 | 5 |
| Pendulum hardness | 144 | 148 | 45 | 55 | 162 |
| after 7d³⁾ | | | | | |
| Solvent resistance⁴⁾ to: | | | | | |
| Water | 4/1/0/0 | 4/2/0/0 | 4/4/3/2 | 2/1/1/0 | 1/0/0/0 |
| Premium-grade petrol | 4/2/1/0 | 4/4/1/0 | 4/4/4/4 | 4/4/3/3 | 4/2/1/1 |
| Methoxypropyl acetate | 4/2/1/0 | 5/4/1/0 | 5/4/4/4 | 4/4/4/4 | 5/4/2/1 |
| Xylene | 4/4/1/0 | 5/4/1/0 | 5/4/4/4 | 4/4/4/4 | 5/4/2/1 |
| FAM test fuel⁵⁾⁶⁾ | 0 | 0 | 3 | 3 | 3 |
| Acetone⁵⁾ | 2 | 1 | 1 | 4 | 4 |
| H₂SO₄ (2% strength)⁵⁾ | 0 | 0 | 0 | 0 | 1 |
| NaOH (2% strength)⁵⁾ | 0 | 0 | 0 | 0 | 1 |
| Cross-cut⁷⁾ | 0 | 0 | 5 | 2 | 2 |
| Scratch resistance⁸⁾ | 1 | 1 | 3 | 2 | 2 |

¹⁾Gloss: to DIN EN ISO 2813
²⁾Haze: ASTM E 430-97
³⁾Pendulum hardness: to DIN EN ISO 1522
⁴⁾Solvent resistance after 2 h, 1d, 3d, 7d: Evaluation: 0-5, 0 = best score
⁵⁾Solvent resistance after 7 d at room temperature: Evaluation: 0-5, 0 = best score
⁶⁾FAM test fuel: to DIN 51604
⁷⁾to DIN EN ISO 2409 to determine the adhesion to cathodic electrocoat: after 7 d at 20° C.: Evaluation 0-5, 0 = best score
⁸⁾Evaluation: 0-5, 0 = best score

It is evident that the hybrid dispersions of the invention (Example 1 and 2 and 6 and 7) have significantly better properties as compared with the dispersions of the prior art (Example 3-5 and 8-10) in aqueous (2K) PU clearcoat materials particularly in respect of pendulum hardness, solvent resistance and chemical resistance, gloss, and scratch resistance.

### Example 11

### Preparation of an Inventive Hybrid Dispersion

In a 4 1 reaction vessel with cooling, heating and stirring apparatus, in a nitrogen atmosphere, 186 g of a linear adipic acid/hexanediol polyester diol having a number-average molecular weight of 2 250, together with 186 g of a linear polyester carbonate diol of number-average molecular weight 2 000 (Desmophen® VP LS 2391, Bayer AG, Leverkusen, DE), 36 g of butanediol-1,4 and 0.6 g of tin(II) octoate, are heated to 80° C. and homogenized for 30 min. Then 117 g of Desmodur® W (4,4′-diisocyanatodicyclohexylmethane, Bayer AG, Leverkusen, DE) are added with vigorous stirring, and the mixture is heated (utilizing the exothermic nature of the reaction) to 140° C. and held at that temperature until NCO groups are no longer detectable. The polyurethane has an average molar weight Mₙ of 5 100 g/mol.

The resulting polyurethane is diluted by addition of 204.7 g of propylene glycol n-butyl ether and then, at 140° C. to 143° C., in a nitrogen atmosphere, first a hydrophobic monomer mixture M1 consisting of 394.5 g of hydroxypropyl methacrylate, 87 g n-butyl acrylate, 90 g of styrene and 91.5 g of methyl methacrylate, followed immediately by a hydrophilic monomer mixture M2 consisting of 145.5 g of hydroxypropyl methacrylate, 75 g of n-butyl acrylate and 52.5 g of acrylic acid, are metered in successively, M1 over 2 hours and M2 over 1 hour, and additionally, in parallel to these two monomer charges, an initiator solution consisting of 39 g of di-t-butyl peroxide in solution in 60 g of propylene glycol n-butyl ether is metered in over 3.5 h (i.e. with 30 minute's extra metering time for the initiator solution). The resulting mixture is then stirred at polymerization temperature for 2 hours and cooled to 90° C. to 100° C., 58.5 g of dimethylethanolamine (degree of neutralization 90%) are added and the mixture is homogenized for about 15 min and then dispersed with 1 985 g of demineralized water. The resultant hybrid resin has an average molecular weight M_{w} of 11 500, an acid number of 28 mg KOH/g and an OH content of 4.5%; the aqueous dispersion, with a viscosity of

2 650 mPas (D=40 s⁻¹, 23° C.), has a solids content of 39%, an average particle size of 140 nm and a pH of 8.1.

### Example 12

### Preparation of an Inventive Hybrid Dispersion

2 576 g of hexahydrophthalic anhydride, 2 226 g of hexane-1,6-diol and 7 g of tin(II) octoate are weighed out into a 5 1 reaction vessel with stirrer, heating apparatus and water separator with cooling apparatus and are heated to 140° C. under nitrogen in one hour. In a further 5 hours heating takes place to 190° C. and condensation is carried out at this temperature until an acid number of less than 3 has been reached. The resultant polyester resin has a viscosity (determined as the flow time over 70% strength solution of the polyester in methoxypropyl acetate from the DIN 4 cup at 23° C.) of 100 seconds and an OH number of 53 mg KOH/g.

In a 4 1 reaction vessel with cooling, heating and stirring apparatus, in a nitrogen atmosphere, 372 g of this polyester, together with 36 g of butanediol-1,4 and 0.6 g of tin(II) octoate, are heated to 80° C. and homogenized for 30 min. Then 117 g of Desmoduro® W (4,4′-diisocyanatodicyclohexylmethane, Bayer AG, Leverkusen, DE) are added with vigorous stirring, and the mixture is heated (utilizing the exothermic nature of the reaction) to 140° C. and held at that temperature until NCO groups are no longer detectable. The polyurethane has an average molar weight Mₙ of 3 940 g/mol.

The resulting polyurethane is diluted by addition of 174.7 g of propylene glycol n-butyl ether and then, at 140° to 143° C., in a nitrogen atmosphere, first a hydrophobic monomer mixture M1 consisting of 394.5 g of hydroxypropyl methacrylate, 76.5 g n-butyl acrylate, 75 g of styrene and 66 g of methyl methacrylate, followed immediately by a hydrophilic monomer mixture M2 consisting of 145.5 g of hydroxypropyl methacrylate, 75 g of n-butyl acrylate and 52.5 g of acrylic acid, are metered in successively, M1 over 2 hours and M2 over 1 hour, and additionally, in parallel to these two monomer charges, an initiator solution consisting of 90 g of di-t-butyl peroxide in solution in 90 g of propylene glycol n-butyl ether is metered in over 3.5 h (i.e. with 30 minute's extra metering time for the initiator solution). The resulting mixture is then stirred at polymerization temperature for 2 hours and cooled to 90° to 100° C., 58.5 g of dimethylethanolamine (degree of neutralization 90%) are added and the mixture is homogenized for about 15 min and then dispersed with 1 800 g of demineralized water. The resultant hybrid resin has an average molecular weight M_{w} of 12 300, an acid number of 28 mg KOH/g and an OH content of 4.5%; the aqueous dispersion, with a viscosity of 2,800 mPas (D=40 s⁻¹, 23° C.), has a solids content of 40%, an average particle size of 220 nm and a pH of 7.9.

### Example 13

### Comparative Example, not Inventive

Blend of the OH-functional polyacrylate dispersion Bayhydrol® VP LS 2271 (46% strength in water/solvent naphtha 100/butylglycol 44.5:6.5:1.5; pH approximately 8, OH content (100% form)=4.5%, acid number (100% form)=22) with the OH-functional polyurethane dispersion Bayhydrol® VP LS 2231 (43% strength in water/N-methylpyrrolidone 54:3; pH approximately 8, OH content (100% form)=3.8%, acid number (100% form)=19) in a 1:1 weight ratio (based on binder in 100% form).

### Example 14

### Clearcoat Materials for Automotive OEM Finishing

The dispersions from Examples 11-13 are formulated to aqueous stock varnishes in accordance with the amounts in Table 2. The polyisocyanate curative is incorporated by means of nozzle jet dispersing at a dispersing pressure of 50 bar. The aqueous coating-materials obtained in this way are sprayed (dry film thickness 30-40 μm) onto a metal panel coated with a solvent-based standard basecoat material, flashed off at room temperature for 5 min, then baked at 80° C. for 10 min and at 130° C. for 30 min. The results of coatings testing are summarized in Table 2.

TABLE 2

| | Weighed amount | | |
|---|---|---|---|
| Component | [parts by weight] | | |
| Ex. 11 | 487.9 | | |
| Ex. 12 | | 470.2 | |
| Ex. 13 | | | 209.5 |
| Bayhydrol ® VP LS 2271 | | | 229.3 |
| Bayhydrol ® VP LS 2231 | | | |
| Tinuvin ® 1130 (50% in BDGA) | 12.9 | 12.9 | 12.9 |
| Tinuvin ® 292 | 6.5 | 6.5 | 6.5 |
| (50% in BDGA = butyldiglycol acetate) | | | |
| Byk ® 345 | 2.1 | 2.1 | 2.1 |
| Byk ® 333 (25% in water) | 2.1 | 2.1 | 2.1 |
| Demineralized water | 101.1 | 28.8 | 58.3 |
| BDGA/solvent naphtha 100 1:1 | 53.0 | 41.4 | 49.7 |
| Desmodur ® N 3600 | 134.3 | 136.0 | 129.7 |

Results of coatings testing:

| | | | |
|---|---|---|---|
| Film optical qualities¹, visual | 2 | 1 | 2 |
| Gloss (20°) | 84 | 86 | 86 |
| Pendulum hardness | 171 | 182 | 186 |
| Solvent resistance²: | | | |
| 1 min | 1025 | 0012 | 1125 |
| 5 min | 2155 | 1025 | 2255 |
| Chemical resistance³ | | | |
| Tree resin | >68 | >68 | 52 |
| Brake fluid | >68 | >68 | >68 |
| Pancreatin | 36 | 36 | 36 |
| NaOH 1% | 59 | 49 | 36 |
| H₂SO₄ 1% | 51 | 53 | 51 |
| Scratch resistance (Δ gloss)⁴ | 11 | 14 | 15 |

¹Texture/levelling, haze: evaluation 0-5; 0 = best score
²Solvent resistance to xylene/MPA/ethyl acetate/acetone: evaluation 0-5 = best score
³Gradient oven method: temperature of the first permanent damage
⁴Loss of gloss (gloss units): on scratching in the Amtec-Kistler laboratory wash installation

It is evident that the hybrid dispersions of the invention (Ex. 11, 12) exhibit advantages in solvent resistance and chemical resistance and also in scratch resistance as compared with the physical blend of polyacrylate dispersion and polyurethane dispersion (Ex. 13) in aqueous 2K PU clearcoat materials, with comparable film optical qualities.

### Example 15

### Preparation of an Inventive Hybrid Dispersion

A 4 1 reaction vessel with cooling, heating, and stirring apparatus is charged under a nitrogen atmosphere with 292.5 g of the polyester from Ex. 15 and this initial charge, together with 285 g of a linear polyestercarbonatediol of number-average molecular weight 2 000 (Desmophen® VP LS 2391, Bayer AG, Leverkusen, DE), 22.5 g of hexane-1,6-diol, 22.5 g of trimethylolpropane, 7.5 g of dimethylol-propionic acid and 0.9 g of tin(II) octoate, is heated to 130° C. and homogenized for 30 min. It is then cooled to 80° C., 120 g of hexamethylene diisocyanate are added with vigorous stirring, and the mixture is heated (utilizing the exothermic nature of the reaction) to 140° C. and held at this temperature until NCO groups are no longer detectable. The polyurethane has an average molar weight Mₙ of 3 620 g/mol.

Subsequently the resultant polyurethane is diluted by adding 204.7 g of propylene glycol n-butyl ether and then, at 140° to 143° C., under a nitrogen atmosphere, first a hydrophobic monomer mixture M1 consisting of 333 g of hydroxypropyl methacrylate, 87 g of n-butyl acrylate and 150 g of isobbmyl methacrylate and directly thereafter a hydrophilic monomer mixture M2 consisting of 82.5 g of hydroxypropyl methacrylate, 30 g of n-butyl acrylate and 37.5 g of acrylic acid are metered in successively, M1 over 2 hours and M2 over 1 hour, and, in parallel to these two monomer charges, an initiator solution consisting of 30 g of di-t-butyl peroxide in solution in 60 g of propylene glycol n-butyl ether is metered in over 3.5 h (i.e. with 30 minute's extra metering time for the initiator solution). Stirring is then continued at polymerization temperature for 2 hours, the mixture is cooled to 90° to 100° C., 36 g of dimethylethanolamine (degree of neutralization 70%) are added, and the mixture is homogenized for about 15 min and then dispersed with 1 385 g of demineralized water. The resultant hybrid resin has an average molecular weight M_{w} of 13 300, an acid number of 21 mg KOH/g and an OH content of 4.05%; the aqueous dispersion, with a viscosity of 2 100 mPas (D=40 s⁻¹, 23° C.), has a solids content of 46.9%, an average particle size of 140 nm and a pH of 7.5.

To prepare a coating material 100 parts by weight of this dispersion are dispersed with 0.5 part by weight of defoamer DNE (K. Obermayer, Bad Berleburg, DE), 0.9 part by weight of Tego® Wet KL 245 (50% strength in water; Tego Chemie, Essen, DE), 1.3 parts by weight of Byk® 348 (Byk Chemie, Wesel, DE), 3.8 parts by weight of Aquacer® 535 (Byk Chemie, Wesel, DE), 8.8 parts by weight of Silitin® Z 86 (Hoffinann & Söhne, Neuburg, DE), 13.2 parts by weight of Pergopak® M3 (Martinswerk, Bergheim, DE), 4.4 parts by weight of Talc IT Extra (Norwegian Talc, Frankfurt, DE), 35.3 parts by weight of Bayferrox® 318 M (Bayer AG, Leverkusen, DE), 4.4 parts by weight of dulling agent OK 412 (Degussa, Frankfurt, DE) and 65.6 parts by weight of demineralized water to form an aqueous stock varnish component. Subsequently, using a dissolver, 55.2 parts by weight of a 75% strength solution of the polyisocyanate crosslinker Bayhydur® 3100 (Bayer AG, Leverkusen, DE) in methoxypropyl acetate are incorporated. The resultant coating material is applied by spraying (dry film thickness 40 μm-50 μm) to a plastics sheet (e.g. Bayblend® T 65, Bayer-AG, Leverkusen, DE) and after a flash-off time of 10 min is dried at 80° C. for 30 min and then at 60° C. for 16 h. A matt, uniform coating film is obtained which has a silkily soft feel (soft feel touch). The adhesion to the substrate is good. The film exhibits a good level both with regard to condensation exposure (DIN 50017) and with regard to resistance to premium-grade petrol, methoxypropyl acetate, xylene, ethyl acetat, ethanol or water.

### Example 16

### Preparation of an Inventive Hybrid Dispersion

A 4 1 reaction vessel with cooling, heating, and stirring apparatus is charged under a nitrogen atmosphere with 438.7 g of the polyester from Ex. 15 and this initial charge, together with 427.5 g of a linear polyestercarbonatediol of number-average molecular weight 2 000 (Desmophen® VP LS 2391, Bayer AG, Leverkusen, DE), 33.8 g of trimethylolpropane, 45 g of dimethylolpropionic acid and 1.4 g of tin(II) octoate, is heated to 130° C. and homogenized for 30 min. It is then cooled to 80° C., 180 g of hexamethylene diisocyanate are added with vigorous stirring, and the mixture is heated (utilizing the exothermic nature of the reaction) to 140° C. and held at this temperature until NCO groups are no longer detectable. The polyurethane has an average molar weight Mₙ of 3 260 g/mol.

Subsequently the resultant polyurethane is diluted by adding 204.7 g of propylene glycol n-butyl ether and then, at 140°-143° C., under a nitrogen atmosphere, first a hydrophobic monomer mixture M1 consisting of 120 g of hydroxypropyl methacrylate, 120 g of n-butyl acrylate and 120 g of isobomyl methacrylate and 15 g of acrylic acid are metered in successively, this monomer mixture M1 being metered in over 3 hours, and, in parallel thereto an initiator solution consisting of 15 g of di-t-butyl peroxide in solution in 60 g of propylene glycol n-butyl ether is metered in over 3.5 h (i.e. with 30 minute's extra metering time for the initiator solution). Stirring is then continued at polymerization temperature for 2 hours, the mixture is cooled to 90° to 100° C., 34 g of dimethylethanolamine (degree of neutralization 80%) are added, and the mixture is homogenized for about 15 min and then .dispersed with 1 930 g of demineralized water. The resultant hybrid resin has an average molecular weight M_{w} of 10 200, an acid number of 20 mg KOH/g and an OH content of 2%; the aqueous dispersion, with a viscosity of 3 000 mPas (D=40 s⁻¹, 23° C.), has a solids content of 40.2%, an average particle size of about 220 nm and a pH of 7.9.

To prepare a coating material 100 parts by weight of this dispersion are dispersed with 0.3 part by weight of defoamer DNE (K. Obermayer, Bad Berleburg, DE), 0.6 part by weight of Tego® Wet KL 245 (50% strength in water; Tego Chemie, Essen, DE), 0.9 part by weighi of Byk® 348 (Byk Chemie, Wesel, DE), 2.5 parts by weight of Aquacer® 535 (Byk Chemie, Wesel, DE), 5.8 parts by weight of Silitin® Z 86 (Hoffrnann & Sohne, Neuburg, DE), 8.6 parts by weight of Pergopak® M3 (Martinswerk, Bergheim, DE), 2.9 parts by weight of Talc IT Extra (Norwegian Talc, Frankfurt, DE), 23.0 parts by weight of Bayferrox® 318 M (Bayer AG, Leverkusen, DE), 2.9 parts by weight of dulling agent OK 412 (Degussa, Frankfurt, DE) and 44.9 parts by weight of demineralized water to form an aqueous stock varnish component. Subsequently, using a dissolver, 23.2 parts by weight of a 75% strength solution of the polyisocyanate crosslinker Bayhydur® 3100 (Bayer AG, Leverkusen, DE) in methoxypropyl acetate are incorporated. The resultant coating material is applied by spraying (dry film thickness about 30 pm) to a plastics sheet (e.g. Bayblend® T 65, Bayer AG, Leverkusen, DE) and after a flash-off time of 10 min is dried at 80° C. for 30 min and then at 60° C. for 16 h. A matt, uniform coating film is obtained which has a silkily soft feel (soft feel touch). The adhesion to the substrate is very good. On exposure to solvents such as premium-grade petrol, methoxypropyl acetate, xylene, ethyl acetate, ethanol or water, for example, the film exhibits a good level of resistance; also deserving of emphasis is the particularly good resistance in the condensation test (to DIN 50017).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing polyurethane-polyacrylate hybrid secondary dispersions, comprising
(I) preparing a polyurethane (A) having an average molecular weight Mₙ of from 1,100 to 10,000, which contains no polymerizable double bonds, in non-aqueous solution, in the presence where appropriate of vinylically unsaturated monomers which carry no groups that are reactive towards isocyanate groups,
(II) adding to the polyurethane solution (A), one or more vinylically unsaturated monomers (B) selected from at least one of the group containing
(B1) acid-functional monomers,
(B2) hydroxyl- and/or amino-functional monomers,
(B3) other monomers different from (B1) and (B2), and subjecting the resultant mixture to free-radical polymerization in a homogeneous, non-aqueous phase to provide a hybrid polymer,
(III) neutralizing at least some of the neutralizable groups, and
(IV) dispersing the hybrid polymer into the aqueous phase, wherein the neutralization can take place before or after the vinyl polymerization or during the dispersing step.

2. The process according to claim 1, wherein the polyurethane
(A) is obtained by reacting
(A1) polyisocyanates with at least one compound containing NCO-reactive groups, selected from the group containing
(A2) polyols and/or polyamines having an average molecular weight Mₙ of at least 400,
(A3) compounds containing at least one ionic or potentially ionic group and at least one further isocyanate-reactive group and/or nonionically hydrophilicizing compounds containing at least one further isocyanate-reactive group,
(A4) low molecular mass compounds having a molecular weight Mₙ of less than 400 which are different from (A2), (A3) and (A5) and contain at least two NCO-reactive groups,
(A5) compounds which are monofunctional or contain active hydrogen of different reactivity, these building blocks being located in each case at the chain end of the polymer containing urethane groups.

3. The process according to claim 1, wherein the free-radical polymerization is conducted such that at the end the fraction of the acid-functional monomers in the monomer mixture is higher than at the beginning.

4. A polyurethane-polyacrylate hybrid secondary dispersions obtained according to the process of claim 1.

5. The polyurethane-polyacrylate hybrid secondary dispersions according to claim 4, wherein the hybrid polymer contains hydroxyl groups both in the polyurethane fraction (A) and in the vinylically unsaturated monomers fraction (B).

6. Aqueous-two-component (2K) coating compositions comprising polyurethane-polyacrylate hybrid secondary dispersions according to claim 4 and also at least one crosslinker.

7. The aqueous two-component (2K) coating compositions according to claim 6, wherein the crosslinker is a polyisocyanate.

8. The aqueous two-component (2K) coating compositions according to claim 7, characterized in that the crosslinker is a polyisocyanate containing free isocyanate groups based on aliphatic or cycloaliphatic isocyanates.

9. A process for producing coatings, comprising applying the polyurethane-polyacrylate hybrid secondary dispersions according to claim 4 to substrates selected from the group consisting of concrete, screeding, mineral surfaces, wood, wood-based materials, metal, asphalt-containing or bituminous coverings, plastics surfaces, glass, glass fibres, carbon fibres, woven and non-woven textiles, leather; paper, hard fibres or straw and dried.

10. The process according to claim 9, wherein the substrate is metal or plastic.

11. Substrates coated with aqueous coating compositions comprising polyurethane-polyacrylate hybrid secondary dispersions according to claim 4.

12. The polyurethane-polyacrylate hybrid secondary dispersions according to claim 5, wherein vinylically unsaturated monomers (B) comprise polyacrylates.
